(19) United States
(12) Patent Application Publication
(10) Pub. No.: US 2024/0146444 A1
(43) Pub. Date: May 2, 2024

(54) High-Bandwidth Communication on 5 Gigahertz (Ghz) Band

(71) Applicant: QUALCOMM Incorporated, San Diego, CA (US)

(72) Inventors: Aakanksha Doda, Bangalore (IN); Venkateswara Swamy Bandaru, Bangalore (IN); Vinay Adella, Bangalore (IN)

(21) Appl. No.: 18/051,201

(22) Filed: Oct. 31, 2022

(51) Int. Cl. H04L 1/00

(52) U.S. Cl. CPC H04L 1/0013; H04W 88/08

(57) ABSTRACT

This disclosure provides methods, components, devices and systems for high-bandwidth communication on the 5 GHz band. Some aspects more specifically relate to greater than 160 MHz channel bandwidth communication between wireless communication devices. In one aspect, 240 MHz channel bandwidth communication from two contiguous channel bandwidths of 160 MHz with a punctured channel bandwidth of 80 MHz may be achieved. In some aspects, first devices operating on the 5 GHz band, such as stations (STAs) or access points (APs) may transmit an information element (IE) indicating an ability to operate at greater than 160 MHz and receive an acknowledgement from a second device, and the devices may begin communicating at greater than 160 MHz channel bandwidth. In some other aspects, the first IE may include additional information including channel segment information, puncture bitmap information, extremely high throughput (EHT) information, and modulation coding scheme (MCS) mapping information.

### TECHNICAL FIELD

This disclosure relates generally to wireless communication, and more specifically, to high-bandwidth communication on the 5 gigahertz (GHz) band.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus for wireless communication. The apparatus for wireless communication includes a first processor and a first memory coupled to the first processor. The first processor is configured to establish a virtual access point (VAP) with a wireless communication device in a 5 GHz band and to transmit a first information element (IE) indicating an ability to operate at a channel bandwidth greater than 160 MHz. The first processor is further configured to receive an acknowledgement indicating receipt of the first IE and to communicate with the wireless communication device over the channel bandwidth greater than 160 MHz.

Another innovative aspect of the subject matter described in this disclosure can be implemented in a method for wireless communication at a first station (STA). The method includes establishing a VAP with a second STA in the 5 GHz band and transmitting a first IE indicating an ability to operate at a channel bandwidth greater than 160 MHz. The method further includes receiving an acknowledgement indicating receipt of the first IE and communicating with the second STA over the channel bandwidth greater than 160 MHz.

Another innovative aspect of the subject matter described in this disclosure can be implemented in an apparatus for wireless communication. The apparatus for wireless communication includes a first processor and a first memory coupled to the first processor. The first processor is configured to establish a wireless communication session with a STA in the 5 GHz band and to receive a first information element (IE) indicating an ability to operate at a channel bandwidth greater than 160 MHz. The first processor is further configured to transmit an acknowledgement indicating receipt of the first IE and to communicate with the STA over the channel bandwidth greater than 160 MHz.

Another innovative aspect of the subject matter described in this disclosure can be implemented in a method for wireless communication at an AP. The method includes establishing a connection with a STA in the 5 GHz band and receiving a first IE indicating an ability to operate at a channel bandwidth greater than 160 MHz. The method further includes transmitting an acknowledgement indicating receipt of the first IE and communicating with the STA over the channel bandwidth greater than 160 MHz.

In some examples the channel bandwidth greater than 160 MHz includes a channel bandwidth of 240 MHz. In further examples, the channel bandwidth of 240 MHz can be formed by static puncturing 80 MHz of channel bandwidth within two contiguous channel bandwidths of 160 MHz.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of a wireless communication network including a first STA, a second STA, and a virtual access point (VAP).

FIG. 3 shows a pictorial diagram of two contiguous channel bandwidths of 160 MHz with a punctured channel bandwidth of 80 MHz.

FIG. 4A shows a flowchart illustrating an example process performable at a first STA that supports high-bandwidth communication on the 5 GHz band.

FIG. 4B shows a flowchart illustrating an example process performable at an AP that supports high-bandwidth communication on the 5 GHz band.

FIG. 5 shows a flowchart illustrating an example process performable at a first STA that supports high-bandwidth communication on the 5 GHz band.

FIG. 6 shows a flowchart illustrating an example process performable at a first STA that supports high-bandwidth communication on the 5 GHz band.

FIG. 7 shows a flowchart illustrating an example process performable at a first STA that supports high-bandwidth communication on the 5 GHz band.

FIG. 8 shows a block diagram of an example wireless communication device that supports high-bandwidth communication on the 5 GHz band.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

The 802.11be standard (Wi-Fi 7) provides for high-throughput communication on the 5 GHz Wi-Fi band. As set forth in the standard, operation on the 5 GHz band provides for nominal 160 MHz bandwidth communication between stations (STAs), while operation on 6 GHz band provides for nominal 320 MHz bandwidth communication between STAs. While the nominal 160 MHz channel bandwidth communication provides for fast communication between STAs and access points (APs) operating on the 5 GHz band, greater than 160 MHz channel bandwidth communication may be achieved for devices that include hardware capable of supporting that higher-bandwidth communication. For example, two STAs, or a STA and an AP, operating on the 5 GHz frequency band having the capability of operating at a channel bandwidth of 160 MHz or greater (such as two STAs, or a STA and an AP, that also support 320 MHz channel bandwidth communication on the 6 GHz frequency band) may be configured to communicate with each other on the 5 GHz frequency band at greater than the nominal 160 MHz bandwidth as described herein. Similarly, high-bandwidth communication between a 5 GHz frequency band-operating STA and a 5 GHz frequency band-operating access point (AP) or virtual access point (VAP) may be configured if those devices include hardware that supports greater than the nominal 160 MHz bandwidth communication.

Various aspects relate generally to wireless communication, and more specifically to high-bandwidth communication on the 5 GHz band. Some aspects more specifically relate to operating at a channel bandwidth greater than the nominal 160 MHz channel bandwidth supported by the 5 GHz band. Further aspects relate to operating at a channel bandwidth of 240 MHz. Still further aspects relate to achieving a channel bandwidth of 240 MHz from two contiguous channel bandwidths of 160 MHz with a punctured channel bandwidth of 80 MHz.

In one example, a first STA establishes a VAP with a second STA in the 5 GHz band and transmits a first information element (IE) indicating an ability to operate at a channel bandwidth greater than 160 MHz. The first STA receives an acknowledgement indicating the first IE was received and communication between the first STA and the second STA over the channel bandwidth greater than 160 MHz occurs. The first IE may include information in addition to the indication of an ability to operate at a channel bandwidth greater than 160 MHz. For example, the first IE may include one or more of: channel segment information, puncture bitmap information (i.e., which channel(s) to puncture), extremely high throughput (EHT) information, modulation coding scheme (MCS) mapping information, or other information.

Particular aspects of the subject matter described in this disclosure can be implemented to realize one or more of the following potential advantages. In some examples, a channel bandwidth of 240 MHz may be achieved from two contiguous channel bandwidths of 160 MHz with a punctured channel bandwidth of 80 MHz. In such an example, communication between a first STA and a second STA, or a first STA and an AP, can proceed over a channel bandwidth of 240 MHz, which is greater than the 5 GHz frequency band's nominal channel bandwidth of 160 MHz. In accordance with achieving higher channel bandwidth communication, the communicating devices may experience higher throughput levels and higher data rates. Additionally, the devices may experience greater spectral efficiency as well as lower latency and lower power consumption, among other benefits.

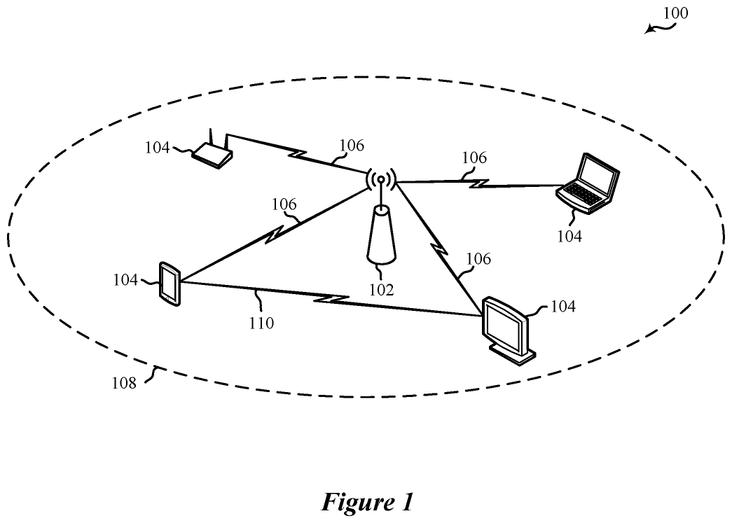

FIG. 1 shows a pictorial diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

In some wireless communications systems, an AP may allocate or assign multiple RUs to a single STA. As increasing bandwidth is supported by emerging standards (such as 802.11be supporting 320 MHz), various multiple RU (multi-RU) combinations may exist. Values indicating the various multi-RU combinations may be provided by a suitable standard specification (such as one or more of the IEEE 802.11 family of wireless communication protocol standards including 802.11be).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing is a wireless communication technique that enables a wireless communication device (such as an AP or a STA) to transmit and receive wireless communications over a portion of a wireless channel exclusive of one or more particular subchannels (hereinafter also referred to as “punctured subchannels”). Static puncturing specifically may be used to exclude one or more subchannels from the transmission of a PPDU, including the signaling of the preamble, to avoid interference from a static source such as an incumbent system. The transmitting device may puncture the subchannels on which there is interference and in essence spread the PPDU to cover the remaining portion of the bandwidth of the channel. For example, if a wireless communication device determines (for example, detects, identifies, ascertains, or calculates) that a 20 MHz subchannel of a 160 MHz or 320 MHz wireless channel is consistently occupied, the wireless communication device can use channel puncturing to avoid communicating over the occupied subchannel while still utilizing the remaining 140 MHz or 300 MHz of bandwidth. Accordingly, channel puncturing allows a wireless communication device to improve or maximize its throughput by utilizing more of the available spectrum that would otherwise have been idle. Static puncturing in particular makes it possible to consistently use wide channels in environments where there is insufficient contiguous spectrum available. Additionally, puncturing also may be used in conjunction with multi-RU transmissions to enable wide channels to be established using non-contiguous spectrum blocks. In such examples, the portion of the bandwidth between two RUs allocated to a particular STA may be punctured. Accordingly, spectrum efficiency and flexibility may be increased.

STA-specific RU allocation information is included in the EHT-SIG field of the PPDU's preamble. Because RUs may be individually allocated in a MU PPDU, use of the MU PPDU format may indicate preamble puncturing for SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

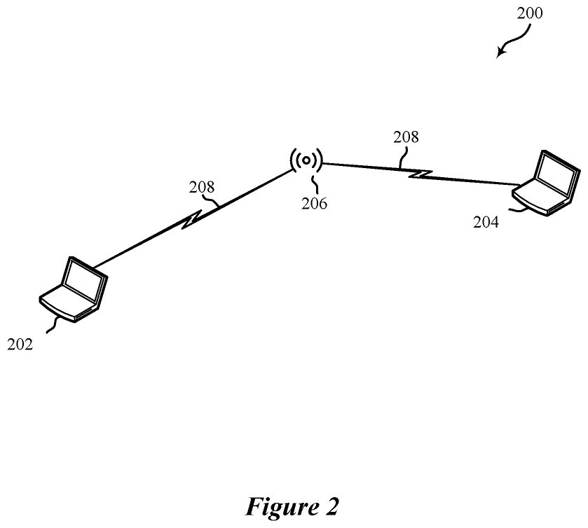

FIG. 2 shows a pictorial diagram of a wireless communication network 200 including a first STA 202, a second STA 204, and a VAP 206. Each of the first and second STAs may be configured to operate on the 5 GHz Wi-Fi frequency band. The first STA 202 or the second STA 204 may be configured to create the VAP 206 for establishing communication with the other STA. In some examples, additional STAs may establish communication with either of the first STA 202 or the second STA 204.

The first STA 202 and the second STA 204 each include a first memory and a first processor coupled with the memory, with the at least one processor operable to cause the respective STA to perform operations such as enabling various modes of operation of the STA and to implement communications and features of the STA.

The first STA 202 and the second STA 204 may be 802.11be compatible devices and support communication in the 2.4 GHz band, the 5 GHz band, and the 6 GHz band, or combinations thereof.

In some implementations, the VAP 206 operates on the 5 GHz band and allows the first STA 202 and second STA to broadcast their respective ability to operate at a nominal channel bandwidth of 160 MHz to inform and allow the STAs to communicate to other STAs and devices and to operate with standard beacon, probe requests, probe responses, association requests, association responses, and other communications.

In the implementation of the wireless communication network 200 depicted in FIG. 2, the first STA 202 may create the VAP 206 enabling communication between the first STA 202 and the second STA 204 via wireless associations 208. In some other implementations, the second STA 204 may create the VAP 206 enabling communication between the first STA 202 and the second STA 204.

In some implementations, additional stations or other devices may be in communication with the first STA 202 or the second STA 204, with corresponding additional wireless associations and corresponding VAPs for each additional station or device.

With the first STA 202 and the second STA 204 in communication via wireless associations 208, the first STA 202 may instigate greater than 160 MHz channel bandwidth communication by transmitting a first IE indicating an ability of the first STA to operate at a channel bandwidth greater than 160 MHz.

Upon receipt of the first IE by the second STA 204, the second STA 204 may respond to the first STA 202 with an acknowledgement of an ability of the second STA 204 to operate at a channel bandwidth greater than 160 MHz. With both the first STA 202 and the second STA 204 indicating an ability to operate at a channel bandwidth greater than 160 MHz, the processor of each of the respective first STA 202 and the second STA 204 may enable greater than 160 MHz channel bandwidth communication in the respective STAs and communication between the first STA 202 and the second STA 204 may commence via wireless associations 208 at a channel bandwidth greater than 160 MHz.

In some implementations, if the second STA 204 does not support communication at a channel bandwidth of greater than 160 MHz, the second STA 204 may ignore the first IE sent by the first STA 202 and communication at a channel bandwidth greater than 160 MHz may not be enabled between the first STA 202 and the second STA 204. In some other implementations, the second STA 204 may respond to the received first IE by transmitting an indication of an inability to communicate at a channel bandwidth greater than 160 MHz.

In further implementations, additional stations may connect to the first STA 202, with each of the additional station establishing a corresponding wireless association with the first STA 202, with the first STA 202 instigating communication with the additional stations at a channel bandwidth greater than 160 MHz.

In additional implementations, greater than 160 MHz channel bandwidth communication may be instigated by the second STA 204, or by additional STAs, rather than by the first STA 202.

In some other implementations, the first IE may include information in addition to the indication of an ability to operate at a channel bandwidth greater than 160 MHz. For example, the first IE may include one or more of: channel segment information, puncture bitmap information, extremely high throughput (EHT) information, modulation coding scheme (MCS) mapping or index information, or other such channel-related information. The additional information may be used by the first STA 202 in configuring the high-bandwidth communication, may be used by the first STA 202 for purposes other than configuring the high-bandwidth communication, or may not be used by the first STA 202.

In another implementation of the wireless communication network 200 depicted in FIG. 2, an AP (such as AP 102 in FIG. 1) may establish the VAP 206 and greater than 160 MHz channel bandwidth communication between the first STA 202 and the AP may be configured as described above, with the AP receiving the first IE (or other request from the first STA 202) indicating an ability to operate at a channel bandwidth greater than 160 MHz, transmitting an acknowledgement (ACK) indicating receipt of the first IE, and communicating with the first STA 202 over a channel bandwidth greater than 160 MHz, such as 240 MHz.

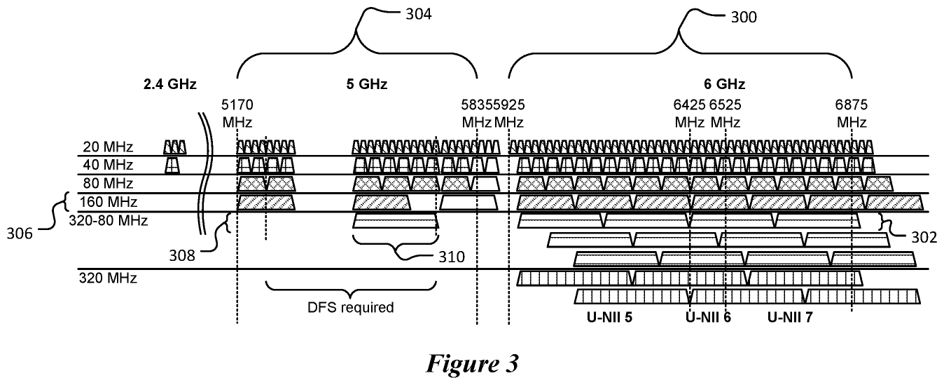

FIG. 3 shows a pictorial diagram of two contiguous channel bandwidths of 160 MHz with a punctured channel bandwidth of 80 MHz.

As set forth in the preliminary specification of the 802.11be standard, while the 6 GHz Wi-Fi band (300) supports 320 MHz bandwidth communication (302), the 5 GHz band (304) does not support contiguous 320 MHz (306). Thus, the nominal highest channel bandwidth communication in the 5 GHz band is 160 MHz (308).

However, STAs or other devices (such as APs) having hardware supporting operation at 320 MHz on the 6 GHz band, such as the first STA 202 and the second STA 204 (or the first STA 202 and an AP, such as the AP 102 described with reference to FIG. 1), may implement greater than 160 MHz channel bandwidth communication on the 5 GHz band by static puncturing within the two contiguous 160 MHz channels. In some implementations, 80 MHz static puncturing of one of the 160 MHz channels can achieve an effective channel bandwidth of 240 MHz (310) (i.e., 320 MHz−80 MHz=240 MHz).

In some implementations, enabling greater than 160 MHz channel bandwidth communication on the first STA 202 and on the second STA 204 includes at least one processor of the respective STAs causing the STAs to enable channel bandwidth communication of 240 MHz by 80 MHz static puncturing of two contiguous 160 MHz channels.

In some implementations, enabling the channel bandwidth communication of greater than 240 MHz, or other channel bandwidth communication of greater than 160 MHz does not impair or disable the ability of the STA to communicate at nominal or standard 160 MHz channel bandwidth communication. For example, the first STA 202 may communicate with the second STA 204 at 240 MHz, while maintaining the ability to communicate at the nominal 160 MHz channel bandwidth.

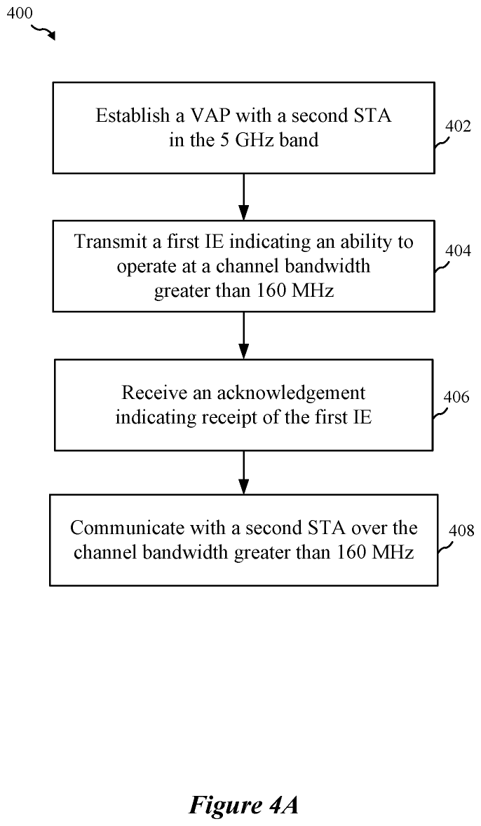

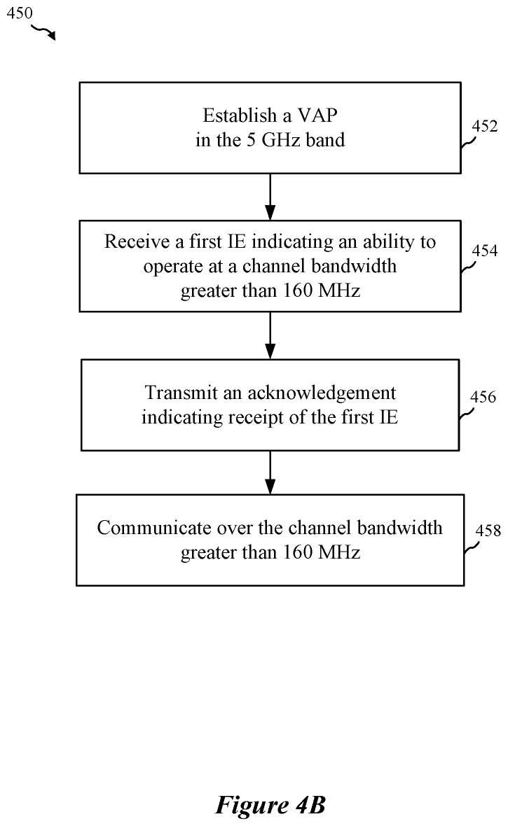

FIG. 4A shows a flowchart illustrating an example process 400 performable at a first STA that supports high-bandwidth communication on the 5 GHz band.

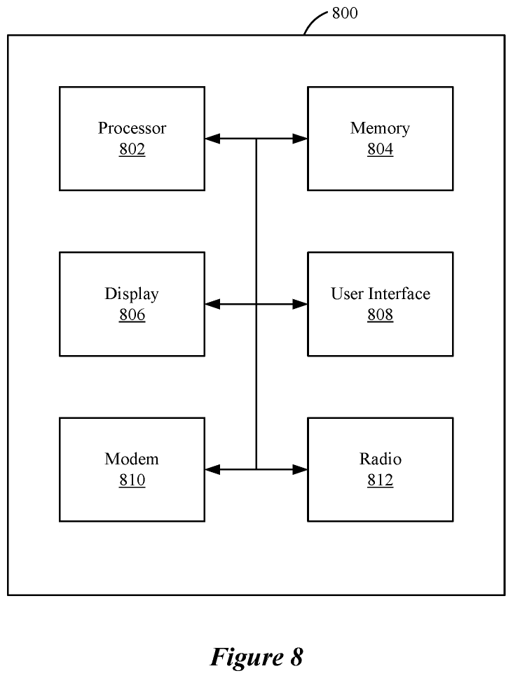

The operations of the process 400 may be implemented by a first STA or its components as described herein. For example, the process 400 may be performed by a wireless communication device, such as the wireless communication device 800 described with reference to FIG. 8, operating as or within a STA. In some examples, the process 400 may be performed by a wireless STA such as one of the STAs 104, or a wireless AP such as the AP 102 described with reference to FIG. 1, or one of the STAs 202 or 204 described with reference to FIG. 2.

In some examples, at block 402, the first STA establishes a VAP with a second station in the 5 GHz band. The VAP also can be established between an AP and a STA (or one or more STAs). At block 404, the first STA transmits a first IE indicating an ability to operate at a channel bandwidth greater than 160 MHz. At block 406, the first STA receives an acknowledgement indicating receipt of the first IE. At block 408 the first STA and the second STA communicate over the channel bandwidth greater than 160 MHz.

FIG. 4B shows a flowchart illustrating an example process 450 performable at an AP that supports high-bandwidth communication on the 5 GHz band.

The operation of the process 450 may be implemented by an AP or its components as described herein. For example, the process 450 may be performed by a wireless communication device, such as the wireless communication device 800 described with reference to FIG. 8, operating as or within an AP. In some examples, the process 450 may be performed by a wireless AP, such as the AP 102 described with reference to FIG. 1.

In some examples, at block 452, the AP may establish a connection with a station in the 5 GHz band. At block 454, the AP receives a first IE indicating an ability to operate at a channel bandwidth greater than 160 MHz. At block 456, the AP transmits an acknowledgement indicating receipt of the first IE. At block 458 the AP communicates with the station over the channel bandwidth greater than 160 MHz.

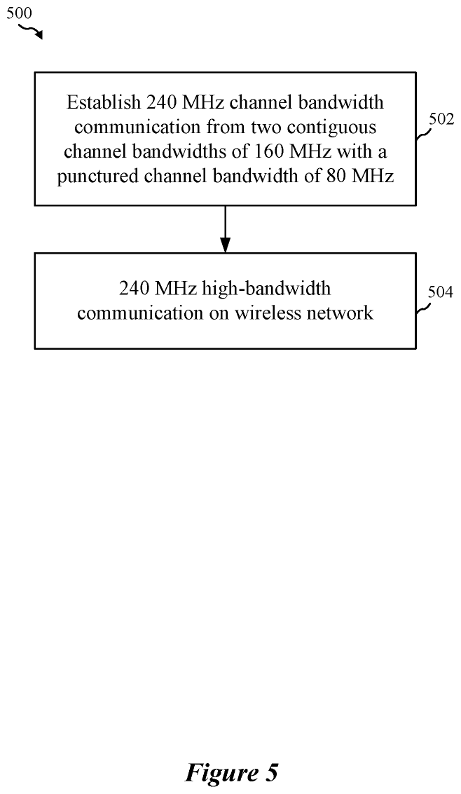

FIG. 5 shows a flowchart illustrating an example process 500 performable at a first STA that supports high-bandwidth communication on the 5 GHz band.

The operations of the process 500 may be implemented by a first STA or its components as described herein. For example, the process 500 may be performed by a wireless communication device, such as the wireless communication device 800 described with reference to FIG. 8, operating as or within a STA or an AP. In some examples, the process 500 may be performed by a wireless STA such as one of the STAs 104, or a wireless AP such as the AP 102 described with reference to FIG. 1, or one of the STAs 202 or 204 described with reference to FIG. 2.

In some examples, communication between the first STA and a second STA (or AP) can be achieved by establishing a channel bandwidth greater than 160 MHz. At block 502, an AP operating on a 160 MHz channel that is contiguous to a 160 MHz channel where the first STA is operating establishes a channel bandwidth of 240 MHz from the two contiguous channel bandwidths of 160 MHz with a punctured channel bandwidth of 80 MHz. At block 504, 240 MHz high-bandwidth communication occurs.

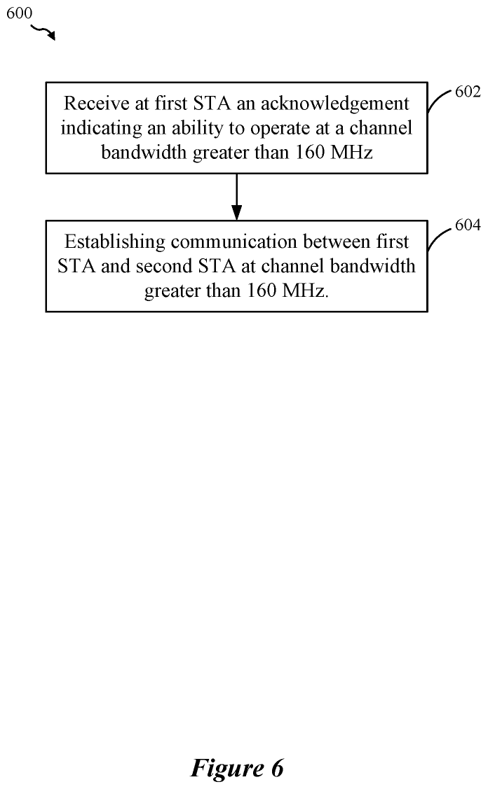

FIG. 6 shows a flowchart illustrating an example process 600 performable at a first STA that supports high-bandwidth communication on the 5 GHz band. The operations of the process 600 may be implemented by a first STA or its components as described herein. For example, the process 600 may be performed by a wireless communication device, such as the wireless communication device 800 described with reference to FIG. 8, operating as or within a STA or an AP. In some examples, the process 600 may be performed by a wireless STA such as one of the STAs 104, or a wireless AP such as the AP 102 described with reference to FIG. 1, or one of the STAs 202 or 204 described with reference to FIG. 2.

At block 602, the first STA receives an acknowledgement indicating an ability to operate at a channel bandwidth of greater than 160 MHz. At block 604, communication between the first STA and the second STA is established at a channel bandwidth greater than 160 MHz.

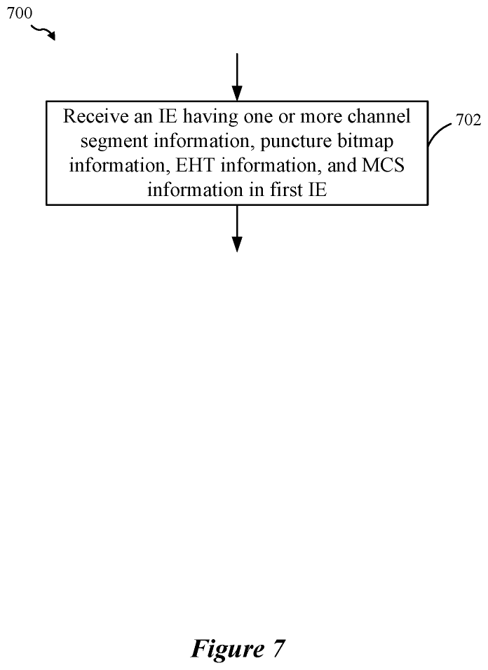

FIG. 7 shows a flowchart illustrating an example process 700 performable at a first STA that supports high-bandwidth communication on the 5 GHz band. The operations of the process 700 may be implemented by a first STA or its components as described herein. For example, the process 700 may be performed by a wireless communication device, such as the wireless communication device 800 describe with reference to FIG. 8, operating as or within a STA or an AP. In some examples, the process 700 may be performed by a wireless STA such as one of the STAs 104, or a wireless AP such as the AP 10 described with reference to FIG. 1, or one of the STAs 202 or 204 described with reference to FIG. 2.

In some examples, at block 702, in addition to an indication of an ability to operate at a channel bandwidth greater than 160 MHz, the received first IE may include one or more of: channel segment information, puncture bitmap information, EHT information, and MCS information. In some implementations, the channel segment information, puncture bitmap information, EHT information, and MCS may be used in conjunction with the indicated ability to operate at a channel bandwidth greater than 160 MHz to establish greater than 160 MHz channel bandwidth communication. In some examples, the channel segment information, puncture bitmap information, EHT information, and MCS may be used independently of the indicated ability to operate at a channel bandwidth greater than 160 MHz, or for other purposes.

FIG. 8 shows a block diagram of an example wireless communication device 800 that supports high-bandwidth communication in the 5 GHz band according to some aspects of the present disclosure. In some examples, the wireless communication device 800 is configured or operable to perform the processes 400, 500, 600, and 700 as described with reference to FIGS. 4, 5, 6, and 7, respectively. In various examples, the wireless communication device 800 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor” 802); one or more radios (collectively “the radio” 812); and one or more memories or memory blocks (collectively “the memory” 804).

The wireless communication device 800 includes a processor component 802, a memory component 804, and display component 806, a user interface component 808, a modem component 810, and a radio component 812. Portions of one or more of the components 806, 808, 810, and 812 may be implemented at least in part in hardware or firmware. In some examples, at least some of the components 806, 808, 810, and 812 of the device 800 are implemented at least in part by a processor and as software stored in a memory. For example, portions of one or more of the display component 806, the user interface component 808, and the modem component 810 can be implemented as non-transitory instructions (or “code”) executable by the processor 802 to perform the functions or operations of the respective module.

In some implementations, the processor 802 may be a component of a processing system. A processing system may generally refer to a system or series of machines or components that receives inputs and processes the inputs to produce a set of outputs (which may be passed to other systems or components of, for example, the device 800). For example, a processing system of the device 800 may refer to a system including the various other components or subcomponents of the device 800, such as the processor, or a transceiver, or a communications manager, or other components or combinations of components of the device 800. The processing system of the device 800 may interface with other components of the device 800 and may process information received from other components (such as inputs or signals) or output information to other components. For example, a chip or modem of the device 800 may include a processing system, a first interface to output information and a second interface to obtain information. In some implementations, the first interface may refer to an interface between the processing system of the chip or modem and a transmitter, such that the device 800 may transmit information output from the chip or modem. In some implementations, the second interface may refer to an interface between the processing system of the chip or modem and a receiver, such that the device 800 may obtain information or signal inputs, and the information may be passed to the processing system. A person having ordinary skill in the art will readily recognize that the first interface also may obtain information or signal inputs, and the second interface also may output information or signal outputs.

The processor 802 is capable of, configured to, or operable to processes information received through the radio 812 and the modem 810, and processes information to be output through the modem 810 and the radio 812 for transmission through the wireless medium. The processor 802 may perform logical and arithmetic operations based on program instructions stored within the memory 804. The instructions in the memory 804 may be executable (by the processor 802, for example) to implement the methods described herein. In some examples, the processor 802, together with the memory 804, are capable of, configured to, or operable to facilitate high-bandwidth communication on the 5 GHz band.

The memory 804 is capable of, configured to, or operable to store and communicate instructions and data to and from the processor 802.

The user interface 808 may be any device that allows a user to interact with the wireless communication device 800, such as a keyboard, a mouse, a microphone, et cetera. In aspects, the user interface 808 may be integrated with the display component 806 to present a touchscreen.

The modem 810 is capable of, configured to, or operable to modulate packets and to output the modulated packets to the radio 812 for transmission over the wireless medium. The modem 810 is similarly configured to obtain modulated packets received by the radio 812 and to demodulate the packets to provide demodulated packets.

The radio 812 includes at least one radio frequency transmitter and at least one radio frequency receiver, which may be combined into one or more transceivers. The transmitter(s) and receiver(s) may be coupled to one or more antennas. In some aspects, the processor 802, the memory 804, the modem 810, and the radio 812 may collectively facilitate the wireless communication of the wireless communication device 800 with other wireless communication devices over multiple frequency bands (such as 2.4 GHz, 5 GHz or 6 GHz).

In some examples, the wireless communication device 800 can be a device for use in a STA, such as STA 104 described with reference to FIG. 1. In some other examples, the wireless communication device 800 can be a STA that includes such a chip, SoC, chipset, package or device as well as multiple antennas. The wireless communication device 800 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 800 also includes or can be coupled with an application processor which may be further coupled with another memory. In some examples, the wireless communication device 800 further includes a user interface (UI) (such as a touchscreen or keypad) and a display, which may be integrated with the UI to form a touchscreen display. In some examples, the wireless communication device 800 may further include one or more sensors such as, for example, one or more inertial sensors, accelerometers, temperature sensors, pressure sensors, or altitude sensors.

In some examples, the wireless communication device 800 can be a device for use in an AP, such as AP 102 described with reference to FIG. 1. In some other examples, the wireless communication device 800 can be an AP that includes such a chip, SoC, chipset, package or device as well as multiple antennas. The wireless communication device 800 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 800 also includes or can be coupled with an application processor which may be further coupled with another memory. In some examples, the wireless communication device 800 further includes at least one external network interface that enables communication with a core network or backhaul network to gain access to external networks including the Internet.

Implementation examples are described in the following numbered clauses:
Clause 1: A method for wireless communication at a first station, including: establishing a virtual access point (VAP) with a second station in a 5 GHz band; transmitting a first information element (IE) indicating an ability to operate at a channel bandwidth greater than 160 MHz; receiving an acknowledgement indicating receipt of the first IE; and communicating with the second station over the channel bandwidth greater than 160 MHz.
Clause 2: The method of clause 1, where the channel bandwidth greater than 160 MHz includes a channel bandwidth of 240 MHz.
Clause 3: The method of clause 2, where the channel bandwidth of 240 MHz includes two contiguous channel bandwidths of 160 MHz with a punctured channel bandwidth of 80 MHz.
Clause 4: The method of clause 1, further including: receiving an acknowledgement indicating an ability to operate at the channel bandwidth greater than 160 MHz.
Clause 5: The method of clause 1, further including: receiving an indication of an inability to operate at the channel bandwidth greater than 160 MHz.
Clause 6: The method of clause 1, where the first IE includes channel segment information, puncture bitmap information, extremely high throughput (EHT) information, modulation coding scheme (MCS) mapping information, or combinations thereof.
Clause 7: An apparatus for wireless communication, including: a first processor and a first memory coupled to the first processor, the first processor configured to: establish a virtual access point (VAP) with a wireless communication device in a 5 GHz band; transmit a first information element (IE) indicating an ability to operate at a channel bandwidth greater than 160 MHz; receive an acknowledgement indicating receipt of the first IE; and communicate with the wireless communication device over the channel bandwidth greater than 160 MHz.
Clause 8: The apparatus of clause 7, where the channel bandwidth greater than 160 MHz includes a channel bandwidth of 240 MHz.
Clause 9: The apparatus of clause 8, where the channel bandwidth of 240 MHz includes two contiguous channel bandwidths of 160 MHz with a punctured channel bandwidth of 80 MHz.
Clause 10: The apparatus of clause 7 where the first processor is further configured to: receive an acknowledgement indicating an ability to operate at the channel bandwidth greater than 160 MHz.
Clause 11: The apparatus of clause 7, where the first processor is further configured to: receive an indication of an inability to operate at the channel bandwidth greater than 160 MHz.
Clause 12: The apparatus of clause 7, where the first IE includes channel segment information, puncture bitmap information, extremely high throughput (EHT) information, modulation coding scheme (MCS) mapping information, or combinations thereof
Clause 13: A method for wireless communication at an access point (AP), including: establishing a connection with a station in a 5 GHz band; receiving a first information element (IE) indicating an ability to operate at a channel bandwidth greater than 160 MHz; transmitting an acknowledgement indicating receipt of the first IE; and communicating with the station over the channel bandwidth greater than 160 MHz.
Clause 14: The method of clause 13, where the channel bandwidth greater than 160 MHz includes a channel bandwidth of 240 MHz.
Clause 15: The method of clause 14, where the channel bandwidth of 240 MHz includes two contiguous channel bandwidths of 160 MHz with a punctured channel bandwidth of 80 MHz.
Clause 16: The method of clause 13, further including: transmitting an acknowledgement indicating an ability to operate at the channel bandwidth greater than 160 MHz.
Clause 17: The method of clause 13, further including: transmitting an indication of an inability to operate at the channel bandwidth greater than 160 MHz.
Clause 18: The method of clause 13, where the first IE includes channel segment information, puncture bitmap information, extremely high throughput (EHT) information, modulation coding scheme (MCS) mapping information, or combinations thereof
Clause 19: An apparatus for wireless communication, including: a first processor and a first memory coupled to the first processor, the first processor configured to: establish a wireless communication session with a station in a 5 GHz band; receive a first information element (IE) indicating an ability to operate at a channel bandwidth greater than 160 MHz; transmit an acknowledgement indicating receipt of the first IE; and communicate with the station over the channel bandwidth greater than 160 MHz.
Clause 20: The apparatus of clause 19, where the channel bandwidth greater than 160 MHz includes a channel bandwidth of 240 MHz.
Clause 21: The apparatus of clause 20, where the channel bandwidth of 240 MHz includes two contiguous channel bandwidths of 160 MHz with a punctured channel bandwidth of 80 MHz.
Clause 22: The apparatus of clause 19, where the first processor is further configured to: transmit an acknowledgement indicating an ability to operate at the channel bandwidth greater than 160 MHz.
Clause 23: The apparatus of clause 19, where the first processor is further configured to: transmit an indication of an inability to operate at the channel bandwidth greater than 160 MHz.
Clause 24: The apparatus of clause 19, where the first IE includes channel segment information, puncture bitmap information, extremely high throughput (EHT) information, modulation coding scheme (MCS) mapping information, or combinations thereof
Clause 25: The method of any of clauses 1 through 3, further including: receiving an acknowledgement indicating an ability to operate at the channel bandwidth greater than 160 MHz.
Clause 26: The method of any of clauses 1 through 2, further including receiving an indication of an inability to operate at the channel bandwidth greater than 160 MHz.
Clause 27: The method of any of clauses 1 through 2, where the first IE includes channel segment information, puncture bitmap information, extremely high throughput (EHT) information, modulation coding scheme (MCS) mapping information, or combinations thereof
Clause 28: The method of any of clauses 13 through 15, further including: transmitting an acknowledgement indicating an ability to operate at the channel bandwidth greater than 160 MHz.
Clause 29: The method of any of clauses 13 through 14, further including transmitting an indication of an inability to operate at the channel bandwidth greater than 160 MHz.
Clause 30: The method of any of clauses 13 through 14, where the first IE includes channel segment information, puncture bitmap information, extremely high throughput (EHT) information, modulation coding scheme (MCS) mapping information, or combinations thereof
Clause 31: The apparatus of any of clauses 7 through 9, where the first processor is further configured to: receive an acknowledgement indicating an ability to operate at the channel bandwidth greater than 160 MHz.
Clause 32: The apparatus of any of clauses 7 through 8, where the first processor is further configured to: receive an indication of an inability to operate at the channel bandwidth greater than 160 MHz.
Clause 33: The apparatus of any of clauses 7 through 8, where the first IE includes channel segment information, puncture bitmap information, extremely high throughput (EHT) information, modulation coding scheme (MCS) mapping information, or combinations thereof
Clause 34: The apparatus of any of clauses 19 through 21, where the first processor is further configured to: transmit an acknowledgement indicating an ability to operate at the channel bandwidth greater than 160 MHz.
Clause 35: The apparatus of any of clauses 19 through 20, where the first processor is further configured to: receive an indication of an inability to operate at the channel bandwidth greater than 160 MHz.
Clause 36: The apparatus of any of clauses 19 through 20, where the first IE includes channel segment information, puncture bitmap information, extremely high throughput (EHT) information, modulation coding scheme (MCS) mapping information, or combinations thereof
Clause 37: An apparatus for wireless communication, including: means for establishing a virtual access point (VAP) with a wireless communication device in a 5 GHz band; means for transmitting a first information element (IE) indicating an ability to operate at a channel bandwidth greater than 160 MHz; means for receiving an acknowledgement indicating receipt of the first IE; and means for communicating with the wireless communication device over the channel bandwidth greater than 160 MHz.
Clause 38: The apparatus of clause 37, where the channel bandwidth greater than 160 MHz includes a channel bandwidth of 240 MHz.
Clause 39: The apparatus of clause 38, where the channel bandwidth of 240 MHz includes two contiguous channel bandwidths of 160 MHz with a punctured channel bandwidth of 80 MHz.
Clause 40: The apparatus of clause 37, where the means for receiving is further configured to: receive an acknowledgement indicating an ability to operate at the channel bandwidth greater than 160 MHz.
Clause 41: The apparatus of clause 37, where the means for receiving is further configured to: receive an indication of an inability to operate at the channel bandwidth greater than 160 MHz.
Clause 42: The apparatus of clause 37, where the first IE includes channel segment information, puncture bitmap information, extremely high throughput (EHT) information, modulation coding scheme (MCS) mapping information, or combinations thereof
Clause 43: An apparatus for wireless communication, including: a means for establishing a wireless communication session with a station in a 5 GHz band; a means for receiving a first information element (IE) indicating an ability to operate at a channel bandwidth greater than 160 MHz; a means for transmitting an acknowledgement indicating receipt of the first IE; and a means for communicating with the station over the channel bandwidth greater than 160 MHz.
Clause 44: The apparatus of clause 43, where the channel bandwidth greater than 160 MHz includes a channel bandwidth of 240 MHz.
Clause 45: The apparatus of clause 44, where the channel bandwidth of 240 MHz includes two contiguous channel bandwidths of 160 MHz with a punctured channel bandwidth of 80 MHz.
Clause 46: The apparatus of clause 43, where the means for transmitting is further configured to: transmit an acknowledgement indicating an ability to operate at the channel bandwidth greater than 160 MHz.
Clause 47: The apparatus of clause 43, where the means for transmitting is further configured to: transmit an indication of an inability to operate at the channel bandwidth greater than 160 MHz.
Clause 48: The apparatus of clause 43, where the first IE includes channel segment information, puncture bitmap information, extremely high throughput (EHT) information, modulation coding scheme (MCS) mapping information, or combinations thereof
Clause 49: A non-transitory computer-readable medium having instructions stored thereon that when executed by a processor cause the processor to perform a method for wireless communication at a first station, the method including: establishing a virtual access point (VAP) with a second station in a 5 GHz band; transmitting a first information element (IE) indicating an ability to operate at a channel bandwidth greater than 160 MHz; receiving an acknowledgement indicating receipt of the first IE; and communicating with the second station over the channel bandwidth greater than 160 MHz.
Clause 50: The non-transitory computer-readable medium of clause 49, where the channel bandwidth greater than 160 MHz includes a channel bandwidth of 240 MHz.
Clause 51: The non-transitory computer-readable medium of clause 50, where the channel bandwidth of 240 MHz includes two contiguous channel bandwidths of 160 MHz with a punctured channel bandwidth of 80 MHz.
Clause 52: The non-transitory computer-readable medium of clause 49, the method further including: receiving an acknowledgement indicating an ability to operate at the channel bandwidth greater than 160 MHz.
Clause 53: The non-transitory computer-readable medium of clause 49, the method further including: receiving an indication of an inability to operate at the channel bandwidth greater than 160 MHz.
Clause 54: The non-transitory computer-readable medium of clause 49, where the first IE includes channel segment information, puncture bitmap information, extremely high throughput (EHT) information, modulation coding scheme (MCS) mapping information, or combinations thereof
Clause 55: A non-transitory computer-readable medium having instructions stored thereon that when executed by a processor cause the processor to perform a method for wireless communication at an access point (AP), the method including: establishing a connection with a station in a 5 GHz band; receiving a first information element (IE) indicating an ability to operate at a channel bandwidth greater than 160 MHz; transmitting an acknowledgement indicating receipt of the first IE; and communicating with the station over the channel bandwidth greater than 160 MHz.
Clause 56: The non-transitory computer-readable medium of clause 55, where the channel bandwidth greater than 160 MHz includes a channel bandwidth of 240 MHz.
Clause 57: The non-transitory computer-readable medium of clause 56, where the channel bandwidth of 240 MHz includes two contiguous channel bandwidths of 160 MHz with a punctured channel bandwidth of 80 MHz.
Clause 58: The non-transitory computer-readable medium of clause 55, the method further including: transmitting an acknowledgement indicating an ability to operate at the channel bandwidth greater than 160 MHz.
Clause 59: The non-transitory computer-readable medium of clause 55, the method further including: transmitting an indication of an inability to operate at the channel bandwidth greater than 160 MHz.
Clause 60: The non-transitory computer-readable medium of clause 55, where the first IE includes channel segment information, puncture bitmap information, extremely high throughput (EHT) information, modulation coding scheme (MCS) mapping information, or combinations thereof.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A method for wireless communication at a first station, comprising:
establishing a virtual access point (VAP) with a second station in a 5 GHz band;
transmitting a first information element (IE) indicating an ability to operate at a channel bandwidth greater than 160 MHz;
receiving an acknowledgement indicating receipt of the first IE; and
communicating with the second station over the channel bandwidth greater than 160 MHz.

2. The method of claim 1, wherein the channel bandwidth greater than 160 MHz includes a channel bandwidth of 240 MHz.

3. The method of claim 2, wherein the channel bandwidth of 240 MHz includes two contiguous channel bandwidths of 160 MHz with a punctured channel bandwidth of 80 MHz.

4. The method of claim 1, further comprising:
receiving an acknowledgement indicating an ability to operate at the channel bandwidth greater than 160 MHz.

5. The method of claim 1, further comprising:
receiving an indication of an inability to operate at the channel bandwidth greater than 160 MHz.

6. The method of claim 1, wherein the first IE comprises channel segment information, puncture bitmap information, extremely high throughput (EHT) information, modulation coding scheme (MCS) mapping information, or combinations thereof.

7. An apparatus for wireless communication, comprising:
a first processor and a first memory coupled to the first processor, the first processor configured to:
establish a virtual access point (VAP) with a wireless communication device in a 5 GHz band;
transmit a first information element (IE) indicating an ability to operate at a channel bandwidth greater than 160 MHz;
receive an acknowledgement indicating receipt of the first IE; and
communicate with the wireless communication device over the channel bandwidth greater than 160 MHz.

8. The apparatus of claim 7, wherein the channel bandwidth greater than 160 MHz includes a channel bandwidth of 240 MHz.

9. The apparatus of claim 8, wherein the channel bandwidth of 240 MHz includes two contiguous channel bandwidths of 160 MHz with a punctured channel bandwidth of 80 MHz.

10. The apparatus of claim 7 wherein the first processor is further configured to:
receive an acknowledgement indicating an ability to operate at the channel bandwidth greater than 160 MHz.

11. The apparatus of claim 7, wherein the first processor is further configured to:
receive an indication of an inability to operate at the channel bandwidth greater than 160 MHz.

12. The apparatus of claim 7, wherein the first IE comprises channel segment information, puncture bitmap information, extremely high throughput (EHT) information, modulation coding scheme (MCS) mapping information, or combinations thereof.

13. A method for wireless communication at an access point (AP), comprising:
establishing a connection with a station in a 5 GHz band;
receiving a first information element (IE) indicating an ability to operate at a channel bandwidth greater than 160 MHz;
transmitting an acknowledgement indicating receipt of the first IE; and
communicating with the station over the channel bandwidth greater than 160 MHz.

14. The method of claim 13, wherein the channel bandwidth greater than 160 MHz includes a channel bandwidth of 240 MHz.

15. The method of claim 14, wherein the channel bandwidth of 240 MHz includes two contiguous channel bandwidths of 160 MHz with a punctured channel bandwidth of 80 MHz.

16. The method of claim 13, further comprising:
transmitting an acknowledgement indicating an ability to operate at the channel bandwidth greater than 160 MHz.

17. The method of claim 13, further comprising:
transmitting an indication of an inability to operate at the channel bandwidth greater than 160 MHz.

18. The method of claim 13, wherein the first IE comprises channel segment information, puncture bitmap information, extremely high throughput (EHT) information, modulation coding scheme (MCS) mapping information, or combinations thereof.

19. An apparatus for wireless communication, comprising:
a first processor and a first memory coupled to the first processor, the first processor configured to:
establish a wireless communication session with a station in a 5 GHz band;
receive a first information element (IE) indicating an ability to operate at a channel bandwidth greater than 160 MHz;
transmit an acknowledgement indicating receipt of the first 1E; and
communicate with the station over the channel bandwidth greater than 160 MHz.

20. The apparatus of claim 19, wherein the channel bandwidth greater than 160 MHz includes a channel bandwidth of 240 MHz.

21. The apparatus of claim 20, wherein the channel bandwidth of 240 MHz includes two contiguous channel bandwidths of 160 MHz with a punctured channel bandwidth of 80 MHz.

22. The apparatus of claim 19, wherein the first processor is further configured to:
transmit an acknowledgement indicating an ability to operate at the channel bandwidth greater than 160 MHz.

23. The apparatus of claim 19, wherein the first processor is further configured to:
transmit an indication of an inability to operate at the channel bandwidth greater than 160 MHz.

24. The apparatus of claim 19, wherein the first IE comprises channel segment information, puncture bitmap information, extremely high throughput (EHT) information, modulation coding scheme (MCS) mapping information, or combinations thereof.
